(19) United States
(12) Patent Application Publication
(10) Pub. No.: US 2015/0339309 A1
(43) Pub. Date: Nov. 26, 2015

(54) INFORMATION POSTING METHOD FOR A WEBSITE

(71) Applicant: Chong Yea Shaw, Fremont, CA (US)

(72) Inventor: Chong Yea Shaw, Fremont, CA (US)

(21) Appl. No.: 14/284,392

(22) Filed: May 21, 2014

(51) Int. Cl. G06F 17/30; H04L 29/06

(52) U.S. Cl. CPC G06F 17/3089; H04L 67/42

(57) ABSTRACT

A method includes receiving an information posting request from a source platform, and receiving a location of where a media content associated with the information posting request is to be posted. After receiving the location, if the source platform is a mobile platform, then open an email client software on the mobile platform, create an email message, transmit the email message to a website service provider's email address, store the media content in a storage system, and post the media content in a webpage referred by the location so the posted media content is searchable on the website. The email message contains a message body for inputting the media content, a message header having the location automatically embedded in a subject header field of the message header, and the website service provider's email address automatically filled in a recipient address field of the message header.

### BACKGROUND OF THE INVENTION

1. Field of the Invention

The invention relates to an information posting method, and more particularly, to an information posting method for a website on the internet through an email message.

2. Description of the Prior Art

As the mobile devices become more and more powerful, it becomes a daily routine for many people to surf the internet through their mobile devices. However, since the display sizes of these mobile devices are rather small comparing to the desktop or laptop monitors, the traditional approaches to interact with the website are no more suitable for mobile device users. Please refer to FIG. 1. FIG. 1 shows a prior art approach to interact with the website. In FIG. 1, the mobile device 100 shows the application form 110 for the user to select items by checking corresponding boxes. However, this method could be difficult to operate on a mobile device, especially when the item lists are too long to be fully displayed in the display window at once.

To solve the inconvenience, a service provider provided different application programs for mobile device users to view and to upload contents onto its websites. However, creating application programs for different applications is very troublesome and time consuming for the service provider. In addition to the trouble caused to the service provider, users are often frustrated to install different application programs for different applications because the application programs occupy a lot of memory space in the mobile devices, and users are often confused by the associations between icons and application programs after a certain number of icons being presented on the display.

### SUMMARY OF THE INVENTION

One embodiment of the present invention discloses an information posting method for a website. The information posting method comprises receiving an information posting request from a source platform, and receiving a location of where a media content associated with the information posting request is to be posted. After receiving the location, if the source platform is a mobile platform, then open an email client software on the mobile platform, create an email message, transmit the email message to a website service provider's email address, store the media content in a storage system, and post the media content in a webpage referred by the location so the posted media content is searchable on the website. The email message contains a message body for inputting the media content, a message header having the location automatically embedded in a subject header field of the message header, and the service provider's email address automatically filled in a recipient address field of the message header.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a prior art approach to interact with a website.

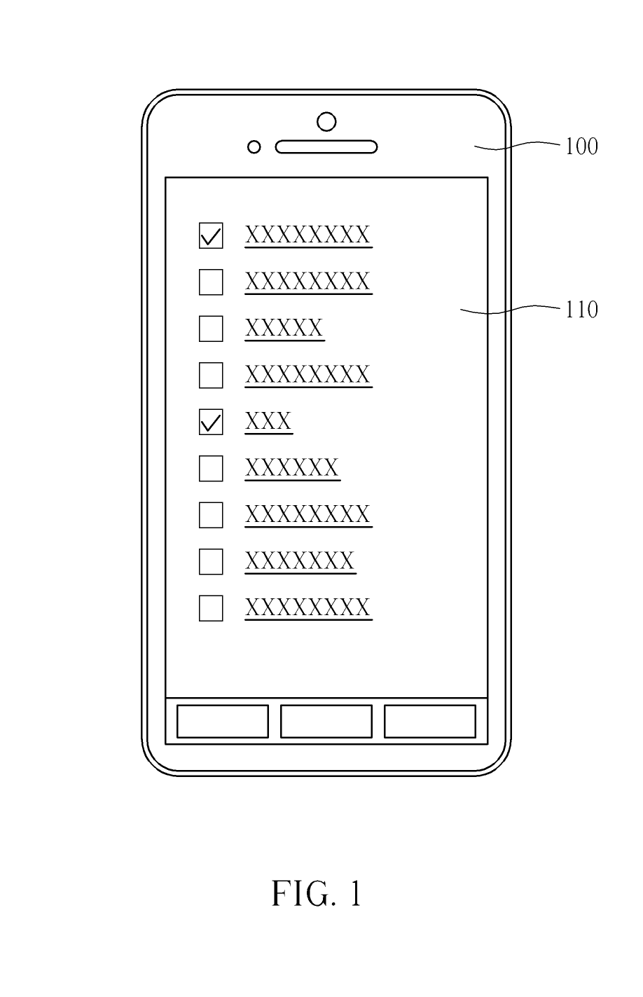

FIG. 2 shows a dataflow of an information posting method for a website according to one embodiment of the present invention.

FIG. 3 shows an information posting method for a website according to one embodiment of the present invention.

FIG. 4 shows an information posting method for a website according to another embodiment of the present invention.

### DETAILED DESCRIPTION

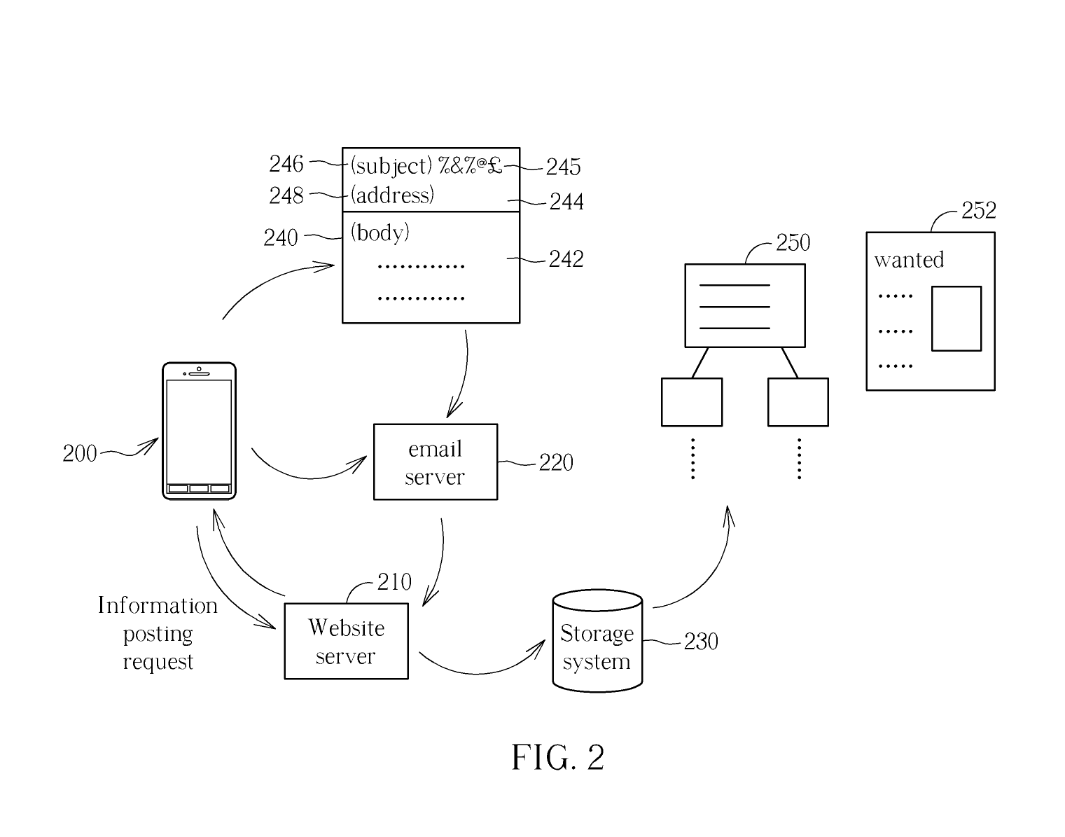

Please refer to FIG. 2. FIG. 2 shows a dataflow of an information posting method for the website 250 according to one embodiment of the present invention. In FIG. 2, the dataflow involves a source platform 200, website server 210, email server 220, storage system 230 and website 250. When a user tries to post a media content on the website 250 by sending an information posting request, the website server 210 will receive the information posting request from the source platform 200. After receiving the information posting request, the website server 210 will check if the source platform 200 is a mobile platform or not. In one embodiment, the source platform information is embedded in the header of the information posting request so the website server 210 can easily identify if the source platform issuing the information posting request is a mobile platform or a desktop platform by software. To determine where the media content will be posted, the website server 210 needs to receive the location where the media content associated with the information posting request is to be posted. For example, suppose the user wants to post an advertisement related to accounting service in San Francisco, the user would have to enter San Francisco as the location so that the website service provider can post the advertisement in the section of the website 250 dedicated to accounting service in San Francisco.

In FIG. 2, suppose the source platform 200 is a mobile platform of a mobile device, the website server 210 will request the source platform 200 to open an email client software on the mobile platform. The email client software may link the source platform 200 to the email server 220 and an email message 240 will be created on the source platform 200. The email client software can be set by user default or user determined. The email message 240 contains a message body 242 for inputting the media content, a message header 244 having the location automatically embedded in a subject header field 246 of the message header 244, and a website service provider's email address automatically filled in a recipient address field 248 of the message header 244. The email server 220 will transmit the email message 240 to the website service provider's email address and the media content will be retrieved and stored in the storage system 230. The storage system 230 can be a database so the media content can be searchable by a web interface software on the website 250, and can be posted in a webpage 252 referred by the location. Also, in other embodiment, the storage system 230 can be a file system.

In one embodiment of the present invention, after the website server 210 receives the email message 240, the website server 210 will check if the media content has violated any posting rule. The media content may comprise text, images and/or multimedia content. Thus the website server 210 may check if the text contains any coarse language and if the images and/or multimedia content contain any inappropriate images or sound. For example, if the website 250 is to provide a job hunting service, the website server 210 may scan the email message 240 to check if it is job search related. In another embodiment of the present invention, the message header 244 further comprises a security code 245 automatically embedded in the subject header field 246. In this case, the website server 210 will verify the validity of the security code 245. This can prevent illegal access of an intruder trying to produce a fake information posting request because the security code 245 can only be generated by the website server 210, and cannot be modified by any user. Moreover, the subject header field 246 can allow the user to enter additional information other than the security code 245 and the location. In one embodiment of the present invention, the security code 245 and the location can be encoded together and embedded in the subject header field 245 to prevent the user from unintentionally modifying the security code 245 and the location. After confirming no posting rule has been violated, the media content can then be posted in the website 250 in the sections indicated by the location. The verification of the posting rule can be done manually or by a software program running on the website server 210.

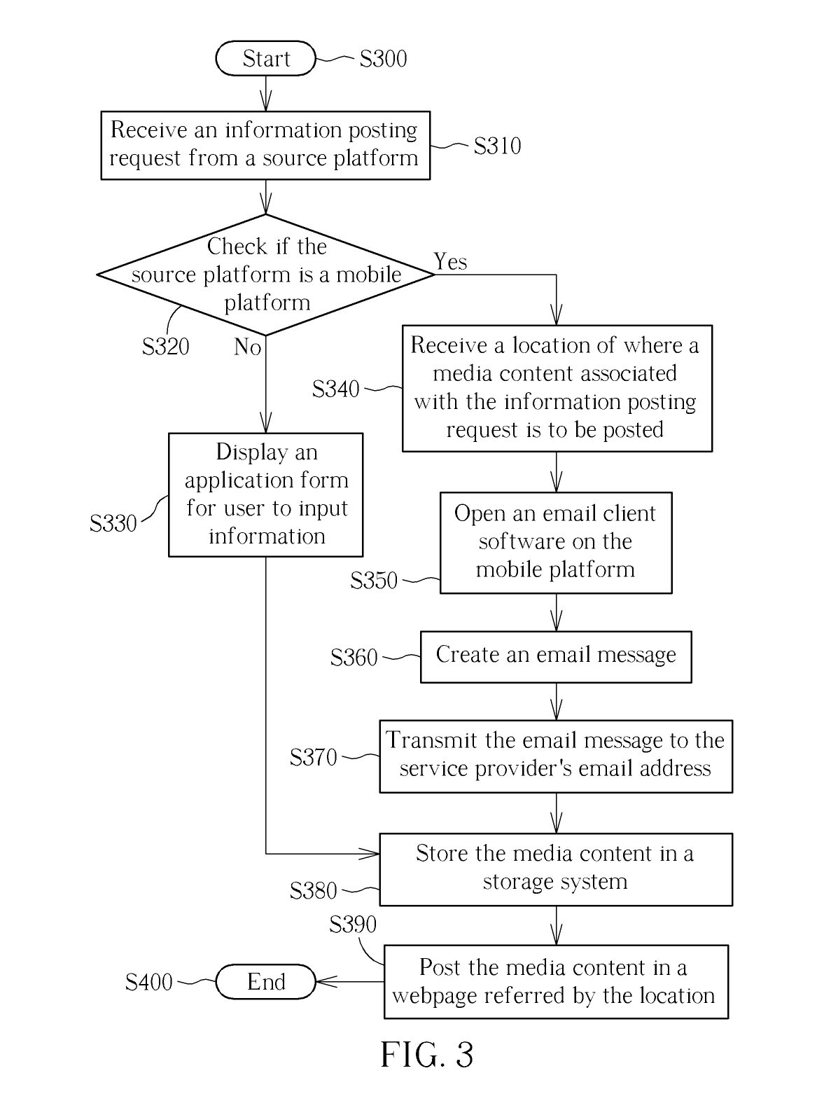

Please refer to FIG. 3. FIG. 3 shows an information posting method for a website according to one embodiment of the present invention. The information posting method in FIG. 3 includes the following steps but not limited to the following sequence. For example, step S350 can be performed before or after step S360.

S300: start;

S310: receive an information posting request from a source platform;

S320: check if the source platform is a mobile platform; if true, go to S340, else go to S330;

S330: display an application form for user to input information, go to S380;

S340: receive a location of where a media content associated with the information posting request is to be posted;

S350: open an email client software on the mobile platform;

S360: create an email message;

S370: transmit the email message to the website service provider's email address;

S380: store the media content in a storage system;

S390: post the media content in a webpage referred by the location;

S400: end.

In step S360, the email message may contain a message body for inputting the media content, a message header having the location automatically embedded in a subject header field of the message header, and a website service provider's email address automatically filled in a recipient address field of the message header. The media content may comprise text, images and/or multimedia content.

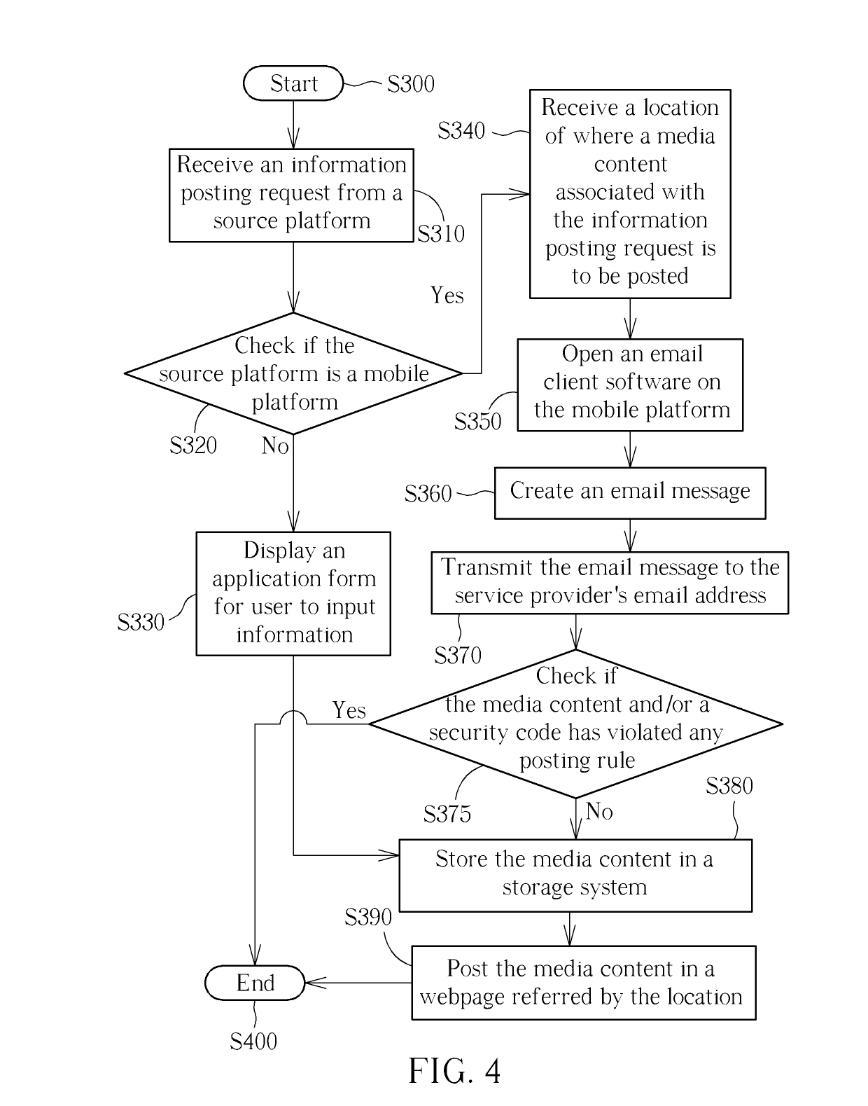

Please refer to FIG. 4, FIG. 4 shows an information posting method for a website according to another embodiment of the present invention. The information posting method in FIG. 4 includes the following steps but not limited to the following sequence. For example, step S350 can be performed before or after step S360.

S300: start;

S310: receive an information posting request from a source platform;

S320: check if the source platform is a mobile platform; if true, go to S340, else go to S330;

S330: display an application form for user to input information, go to S380;

S340: receive a location of where a media content associated with the information posting request is to be posted;

S350: open an email client software on the mobile platform;

S360: create an email message;

S370: transmit the email message to the website service provider's email address;

S375: check if the media content and/or a security code has violated any posting rule; if true, go to S400, else go to S380;

S380: store the media content in a storage system;

S390: post the media content in a webpage referred by the location;

S400: end.

In summary, by using the information posting method according to the aforesaid embodiments of the present invention, a user can post the media content through an email message without filling a long application form on a mobile platform. This can prevent a long list of information from being displayed on a small display of a mobile device, and reduce the effort for the website service provider to create specific application programs for different posting applications. Further the user is no longer requested to download specific application programs for different posting requests.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An information posting method for a website, comprising:
receiving an information posting request from a source platform; and
checking if the source platform is a mobile platform, if true:
receiving a location of where a media content associated with the information posting request is to be posted;
opening an email client software on the mobile platform;
creating an email message containing a message body for inputting the media content, a message header having the location automatically embedded in a subject header field of the message header, and a website service provider's email address automatically filled in a recipient address field of the message header;
transmitting the email message to the website service provider's email address;
storing the media content in a storage system; and
posting the media content in a webpage referred by the location so the posted media content is searchable on the website.

2. The method of claim 1 further comprising checking if the media content has violated any posting rule after the email message is transmitted to the website service provider's email address, wherein the media content is posted when no posting rule is violated.

3. The method of claim 1, wherein the media content comprises text.

4. The method of claim 1, wherein the media content comprises images.

5. The method of claim 1, wherein the media content comprises multimedia content.

6. The method of claim 1, wherein the message header further comprises a security code automatically embedded in the subject header field.

7. The method of claim 6, wherein the subject header field comprises a space for entering additional data.

8. The method of claim 6, further comprising checking if the security code has violated any posting rule after the email message is transmitted to the service provider's email address, wherein the media content is posted when no posting rule is violated.

9. The method of claim 6, wherein the location embedded in the subject header and the security code are unchangeable.

10. The method of claim 1, wherein the contents of the subject can be encoded.

11. The method of claim 1, wherein the storage system comprises a file system.

12. The method of claim 1, wherein the storage system comprises a database.
